(19) United States
(12) Patent Application Publication
(10) Pub. No.: US 2003/0016943 A1
(43) Pub. Date: Jan. 23, 2003

(54) Reproducing apparatus and method of providing bookmark information thereof

(75) Inventors: Hyun-kwon Chung, Gyeonggi-do (KR); Jung-wan Ko, Gyeonggi-do (KR); Bong-gil Bak, Seoul (KR)

Correspondence Address: STAAS & HALSEY LLP, 700 11TH STREET, NW, SUITE 500, WASHINGTON, DC, 20001, US

(73) Assignee: Samsung Electronics Co.Ltd.

(21) Appl. No.: 10/189,785

(22) Filed: Jul. 8, 2002

(30) Foreign Application Priority Data
Jul. 7, 2001 (KR) 2001-40681

(51) Int. Cl. H04N 5/76

(52) U.S. Cl. 386/46; 386/125

(57) ABSTRACT

An apparatus for reproducing content recorded on an information storage medium and a method of providing bookmark information of the reproducing apparatus. Bookmark information, including an annotation input by a user with respect to selected content and a locator necessary for reproducing the selected content, is stored and sent to another reproducing apparatus through a communications link such as the Internet. Accordingly, a user can bookmark the particular location of the predetermined content, annotate the content in one reproducing apparatus and send the bookmark information for presentation on another reproducing apparatus.

### CROSS REFERENCE TO RELATED APPLICATIONS

This application claims the benefit of Korean Application No. 2001-40681 filed Jul. 7, 2001, in the Korean Intellectual Property Office, the disclosure of which is incorporated herein by reference.

### BACKGROUND OF THE INVENTION

1. Field of the Invention

The present invention relates to an information storage medium, and more particularly, to a method of providing bookmark information for a reproducing apparatus, which reproduces contents recorded on an information storage medium.

2. Description of the Related Art

With the development of information storage technology, digital versatile discs (DVDs) and DVD players (reproducing apparatuses) are being used for recording and reproducing multimedia contents, such as films and music. In addition, with the development of communication technology, transmission of multimedia contents via the Internet is being widely used.

Accordingly, in addition to the ability to simply record or reproduce multimedia contents, a user desires a variety of functions. For example, a particular location (scene) is memorized during the reproduction of multimedia contents so that the multimedia contents may be immediately reproduced from the memorized location, or a particular scene is annotated so that the note may be referred to when the particular scene is reproduced the next time. Furthermore, a function for allowing memorized location information to be used in another reproducing apparatus may be desired.

### SUMMARY OF THE INVENTION

Accordingly, it is an object of the present invention to provide a reproducing apparatus supporting a bookmark function allowing annotation by a user and a method of providing bookmark information of the reproducing apparatus.

It is another object of the present invention to provide a method of allowing a bookmark list of one reproducing apparatus to be used in another reproducing apparatus, and a reproducing apparatus therefor.

Additional objects and advantages of the invention will be set forth in part in the description which follows, and, in part, will be obvious from the description, or may be learned by practice of the invention.

To achieve the above and other objects of the invention, there is provided a method of providing bookmark information of a reproducing apparatus, which reproduces content recorded on an information storage medium. The method comprises storing bookmark information comprising an annotation input by a user with respect to selected contents and a locator necessary for reproducing the selected content, and sending the bookmark information to another reproducing apparatus, such as for example, through the Internet. Either the reproducing apparatus or the another reproducing apparatus may then display and use the bookmark information.

To achieve the above and other objects of the invention, there is provided a method of providing bookmark information of a reproducing apparatus, which reproduces content recorded on an information storage medium. The method comprises receiving bookmark information comprising an annotation input by a user with respect to selected contents and a locator necessary for reproducing the selected content from another reproducing apparatus, such as for example, through the Internet, storing the bookmark information, and displaying the stored bookmark information.

The storing of the bookmark information may include reading a locator from navigation information recorded on the information storage medium, and generating the bookmark information by combining the read locator and the annotation. The storing of the bookmark information may also include storing the bookmark information in the information storage medium where the information storage medium on which the content is recorded is a recordable medium and storing the bookmark information in a recordable non-volatile memory where the information storage medium on which the content is recorded is a read only medium.

The storing of the bookmark information may further include storing a recording type of the content, and storing a title name of the content.

The storing of the recording type of the content may include decoding the recording type of the content from the recording medium, on which the content is recorded, and storing the recording type, and the storing of the title name of the content may include decoding the title name of the content from the recording medium, on which the content is recorded, and storing the title name.

The sending of the bookmark information may further comprise sending and receiving the bookmark information by electronic mail. The sending of the bookmark information by electronic mail may further comprise converting the bookmark information into a data format, which can be transferred by electronic mail; attaching the converted bookmark information to the electronic mail; and sending the electronic mail.

To achieve the above and other objects of the invention, there is also provided a reproducing apparatus comprising a reader section which reads predetermined data from an information storage medium; a playback section which reproduces content provided from the reader section; a controller section which stores bookmark information comprising a locator necessary for reproducing content starting from a location selected by a user while the playback section is reproducing the content and an annotation with respect to the content; and an Internet access section which sends the bookmark information to another reproducing apparatus through the Internet under the control of the controller section.

To achieve the above and other objects of the invention, there is also provided a reproducing apparatus comprising a reader section which reads predetermined data from an information storage medium; a playback section which reproduces content provided from the reader section; an Internet access section which receives bookmark information comprising a locator necessary for reproducing content starting from a selected location and an annotation with respect to the content from another reproducing apparatus through the Internet; and a controller section which stores the bookmark information received through the Internet access section or displays the stored bookmark information.

The controller section stores the bookmark information at a section of an area in which navigation information is stored on the information storage medium, where the information storage medium is a recordable medium, or stores the bookmark information in a recordable non-volatile memory. In addition, the controller section attaches the bookmark information to electronic mail and sends the electronic mail to another reproducing apparatus through the Internet access section. The bookmark information may be converted into a data format, which is transferable by electronic mail, attached to the electronic mail, and sent with the electronic mail. The controller section may include a non-volatile memory, in which an electronic mail program code is stored, and a processor, which operates as an electronic mail client by executing the electronic mail program code. The controller section receives predetermined content from an Internet server and displays the predetermined content. The controller section may include a non-volatile memory, in which a browser program code is stored, and a processor, which operates as a browser by executing the browser program code in order to receive and display the predetermined content.

### BRIEF DESCRIPTION OF THE DRAWINGS

The above objects and advantages of the present invention will become more apparent by describing in detail preferred embodiments thereof with reference to the attached drawings in which:

FIG. 1 is a block diagram of the present invention;

FIG. 2 is a block diagram of a reproducing apparatus shown in FIG. 1;

FIG. 3 is a detailed block diagram of the reproducing apparatus shown in FIG. 2;

FIG. 4 illustrates a data structure of bookmark information according to the present invention;

FIG. 5 shows an example of a screen displaying bookmark data according to the present invention;

FIG. 6 shows an example of an input screen on which bookmark data is input according to the present invention;

FIG. 7 shows another example of an input screen on which bookmark data is input according to the present invention;

FIG. 8 shows an example of a send screen through which bookmark data is sent from one reproducing apparatus to another reproducing apparatus according to the present invention;

FIG. 9 shows an example of a bookmark table which stores bookmark information according to the present invention;

FIG. 10 is a flowchart of a method of storing bookmark information;

FIG. 11 is a flowchart of a method of sending bookmark information;

FIG. 12 is a flowchart of a method of storing received bookmark information; and

FIG. 13 is a flowchart of a method of displaying stored bookmark information.

### DESCRIPTION OF THE PREFERRED EMBODIMENTS

Reference will now be made in detail to the present embodiments of the present invention, examples of which are illustrated in the accompanying drawings, wherein like reference numerals refer to like elements throughout.

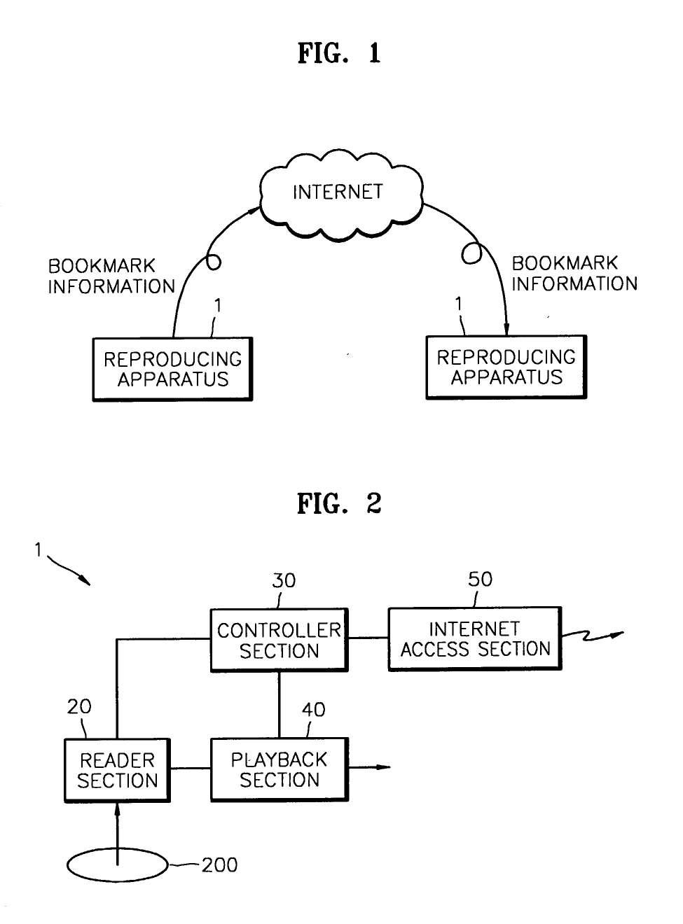

FIG. 1 is a block diagram of the present invention. Referring to FIG. 1, a plurality of reproducing apparatuses 1 according to an embodiment of the present invention are connected to the Internet. One reproducing apparatus 1 is configured to send or receive bookmark information according to the present invention to or from the other reproducing apparatus 1. Each of the reproducing apparatuses 1 may be embodied as a digital versatile disc (DVD) reproducing apparatus. Included in the scope of DVDs are DVD-Video, DVD-Audio, DVD-Interactive, DVD video-recording, and HD-DVD. Since audio/video (AV) data and web documents are recorded on a DVD-Interactive, the DVD-Interactive supports an interactive mode in which the AV data is reproducible through a display window defined by web documents. This will be described below in detail. An HD-DVD is a DVD having high picture quality, which results from a recording density four or five times higher than a DVD manufactured according to current specifications. Adoption of a standard for the data structure of an HD-DVD is now under way. Since distinguishing features of the present invention are not based on the data structure of the HD-DVD, the present invention is applicable to an HD-DVD regardless of the standard of a data structure.

FIG. 2 is a block diagram of the reproducing apparatuses 1 shown in FIG. 1. Referring to FIG. 2, the reproducing apparatus 1 comprises a reader section 20, a controller section 30, a playback section 40, and an Internet access section 50. The reader section 20 reads predetermined data from an optical disc 200. The playback section 40 reproduces content read from the optical disc 200 by the reader section 20. In the present invention, the term “content” indicates various kinds of content recorded on an information storage medium. Accordingly, content includes AV data as well as text data. Where the optical disc 200 is a DVD-Video, movies recorded thereon may be the content and where the optical disc 200 is a DVD-ROM, electronic books (e-books) recorded thereon may be the content, for example. Accordingly, the playback section 40 comprises a decoder which decodes AV data (content according to the present invention) recorded by way of predetermined coding. While the playback section 40 is reproducing AV data, the controller section 30 stores bookmark information about frames bookmarked by a user and displays the bookmark information if necessary. The controller section 30 sends or receives bookmark information to or from another reproducing apparatus 1 through the Internet access section 50. Where the optical disc 200 is a recordable medium, the controller section 30 records bookmark information on the optical disc 200. Where bookmark information is recorded on the optical disc 200 in the embodiment of the present invention, the bookmark information is stored in a section of an area in which navigation information about the AV data is recorded. The Internet access section 50 accesses the Internet to send bookmark information to another reproducing apparatus 1.

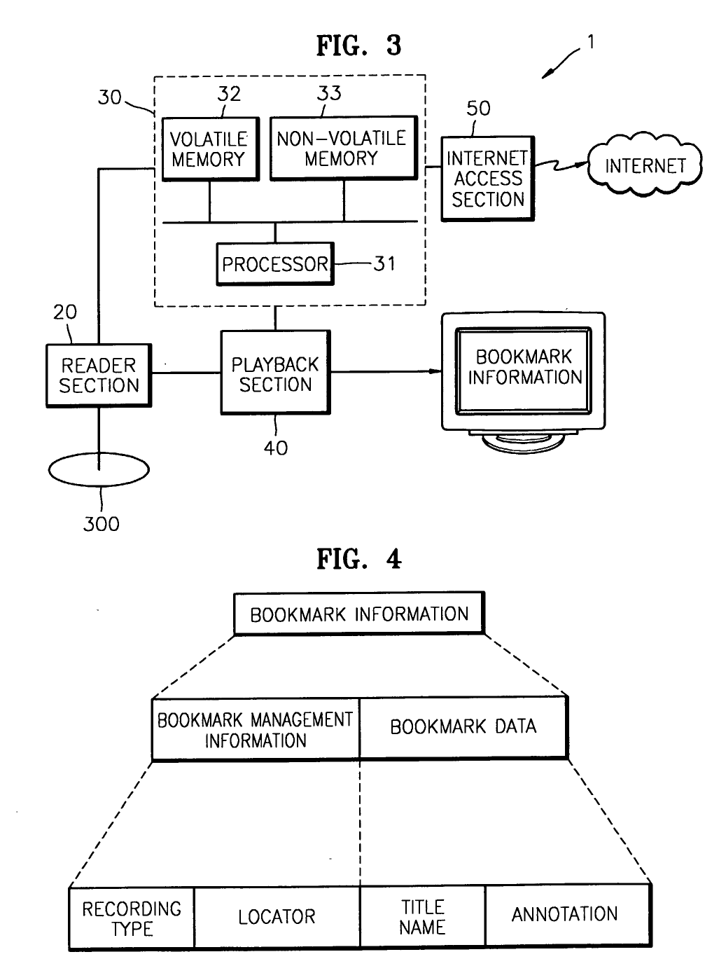

FIG. 3 is a detailed block diagram of the reproducing apparatus 1 shown in FIG. 2. Referring to FIG. 3, the controller section 30 comprises a processor 31, a volatile memory 32, and a non-volatile memory 33. The non-volatile memory 33 stores an e-mail program code and a browser program code. The processor 31 operates as an e-mail client or browser by executing the e-mail program code or the browser program code stored in the non-volatile memory 33. The processor 31, operating as an e-mail client, converts bookmark information into an e-mail transmittable data format and sends e-mail, to which the converted bookmark information is attached, to an e-mail server. In addition, the processor 31 receives e-mail having bookmark information as an attachment from an e-mail server, extracts the bookmark information from the received e-mail, and stores the extracted bookmark information in the non-volatile memory 33. The processor 31, operating as a browser, is adapted to browse the Internet. In other words, the processor 31 receives a variety of content from a predetermined Internet server and displays the content. In addition, where a presentation engine program code for interpreting and displaying, for example, Java or Java script, is stored in the non-volatile memory 33, the processor 31 operates as a presentation engine and supports an interactive mode of a DVD-Interactive.

A DVD-Interactive is obtained by recording information which supports an interactive function on a conventional DVD-Video. Accordingly, AV data recorded on a DVD-Interactive is reproduced in a form of an AV data stream and is displayable in two different modes. One displayable mode is a video mode, in which the AV data is displayed in the same manner as the AV data recorded on a usual DVD-Video. The other displayable mode is an Interactive mode, in which the AV data is displayed through a display window defined by a web document. If a user selects an interactive mode, a browser installed in a DVD reproducing apparatus displays a web document recorded on a DVD-Interactive. AV data selected by the user is reproduced and displayed on the display window of the web document. For example, where the AV data is a movie, the movie is shown on the display window, and various kinds of supplementary information, such as a film script, an introduction and pictures of actors and actresses, is displayed on a screen other than the display window.

FIG. 4 illustrates a data structure of the bookmark information according to the present invention. Referring to FIG. 4, the data structure of bookmark information according to the present invention comprises bookmark management information and bookmark data. The bookmark data comprises a title name of the bookmarked content and an annotation. Annotations are text data recorded by a user. For example, a user may mark and annotate a particular location (frame) while watching AV data (a particular program) recorded on an optical disc 300 of FIG. 3. In other words, the title name of a bookmarked content and an annotation recorded by a user are stored as bookmark data. The bookmark management information is navigation information, which is necessary to search a program for a bookmarked location (a frame in the case of AV data), reproduce the program, and display a relevant annotation. The bookmark management information includes a recording type and a locator.

The recording type indicates the kind of bookmark belonging to the content. For example, content may be AV data recorded on a DVD-Video, DVD-Audio, DVD Video Recording, DVD-ROM, DVD-RAM, or DVD-Interactive or may be an e-book realized as a multimedia file. For example, the recording type may be set to 0 to indicate AV data recorded by the DVD-Video standard, 1 to indicate AV data recorded by the general DVD-ROM standard, 2 to indicate AV data recorded by the DVD-Audio standard, or 3 to indicate an e-book published by a certain company, e.g., ABC company. Bookmark information is recorded in a predetermined position according to the recording type. For example, where the recording type is DVD Video Recording, bookmark information may be recorded in a position of Movie_Cell_Entry Point Information (M_C_EPI) in navigation information.

The locator is information necessary for reproducing relevant content starting with the bookmarked location. The locator indicates the location of the bookmarked content and information necessary for reproduction. For example, where relevant content is stored in an Internet server, the locator is represented by a universal resource locator (URL). A URL is a data format for coherently expressing the addresses of accessible resources. Where content is recorded on a DVD, the locator is extracted from the navigation information of the DVD. More specifically, where content is recorded on a DVD-Video, the locator includes a program number, a cell number, a navigation pack address (NV_PCK address), a program chain playback control status (PGC playback control status), a video title set number (VTSN), a title number, video title set title number (VTS_TTN), a title program chain number (TT_PGCN), a part-of-title number (PTTN), a highlight button number (HL_BTNN), and a disc's unique ID. Where content is recorded on a DVD Video Recording, the locator includes a program number, a cell number, and an entry point (EP). Where content is recorded on a DVD-Interactive, the locator may include a Java script variable status and the URL of a web document displayed on a screen. Where content is recorded on a DVD-Audio, the locator includes an audio title set number (ATSN), a program number (PGN), an audio title group number (ATGN), an audio title number (an ATGN for a title group domain (TT_GR_DOM)), and a track number (a track number for the TT_GR_DOM). Where content is a web document, the locator includes the URL of the web document. As described above, the locator includes different recording types of information according to the kind of content.

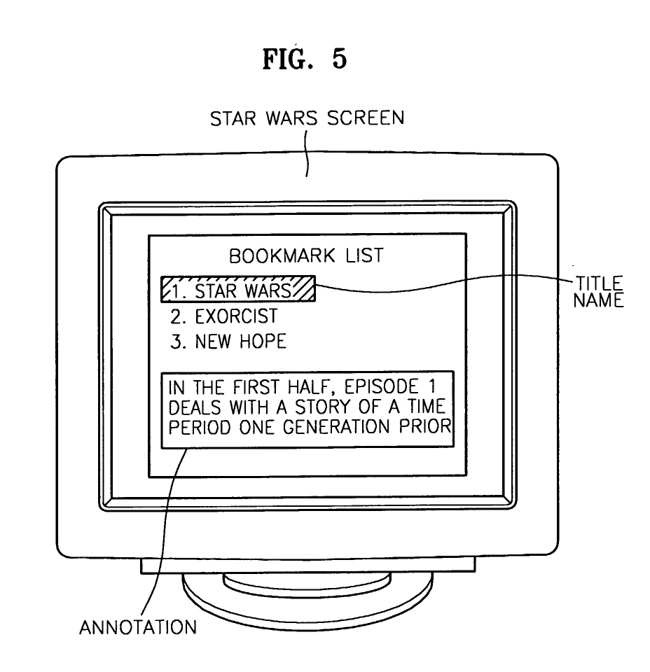

FIG. 5 shows an example of a screen displaying bookmark data according to the present invention. Referring to FIG. 5, title names of bookmarked content are displayed on a screen of a display device provided in or connected to a reproducing apparatus according to the present invention. In addition, an annotation about a selected title name is displayed below the list of title names.

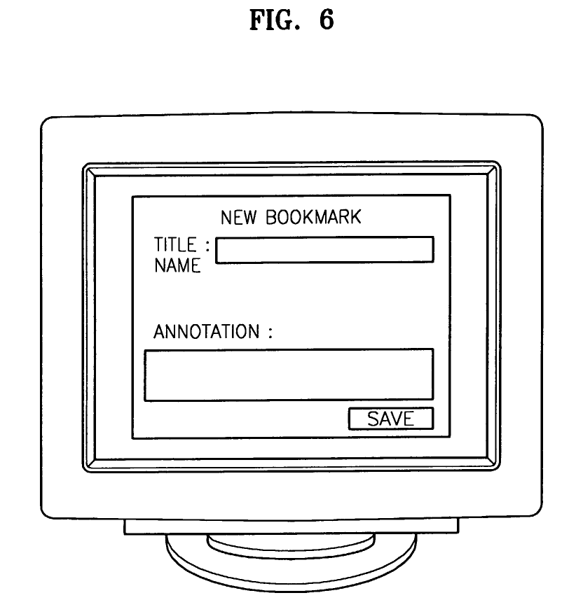

FIG. 6 shows an example of an input screen, on which bookmark data is input according to the present invention. Referring to FIG. 6, an input window for inputting the title name of the content and an input window for inputting an annotation are displayed on an input screen for inputting bookmark data. A user inputs the title name of the content to be bookmarked and an annotation in the respective input windows. If the user clicks the save button after inputting the title name and annotation, bookmark data (the title name and annotation) is stored. An image reproduced from AV data or content (such as a web document) provided from an Internet server is displayed on the background of the input screen.

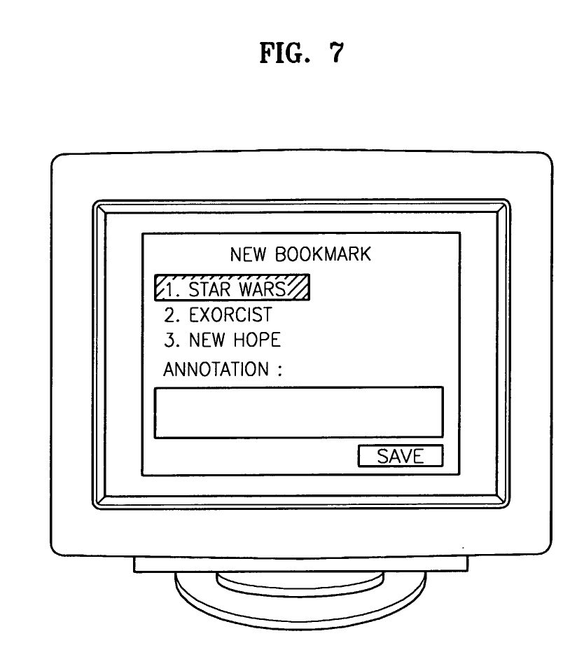

FIG. 7 shows another example of an input screen, on which bookmark data is input according to the present invention. Referring to FIG. 7, an annotation is input through an input window provided below the title names of the content previously bookmarked. On this input screen, a user selects one of the title names having the bookmarked content and inputs an annotation about the selected content. If the user clicks the save button after inputting the annotation, the annotation is stored as bookmark data. Similarly to the example shown in FIG. 6, an image reproduced from AV data or content (such as a web document) provided from an Internet server is displayed on the background of the input screen.

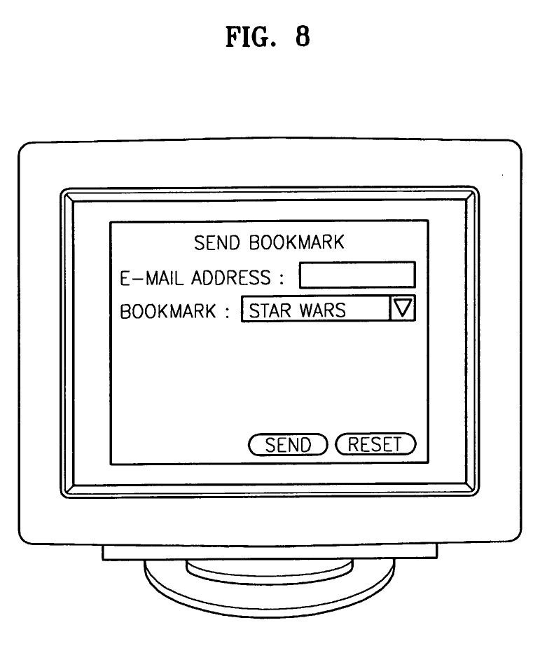

FIG. 8 shows an example of a send screen, through which bookmark data is sent from one reproducing apparatus to another reproducing apparatus according to the present invention. Referring to FIG. 8, the send screen is provided with an input window for inputting an e-mail address and a selection window (BOOKMARK) for selecting bookmark information. A user inputs an e-mail address, selects the bookmark information, and clicks the send button, and the bookmark information is sent to another reproducing apparatus.

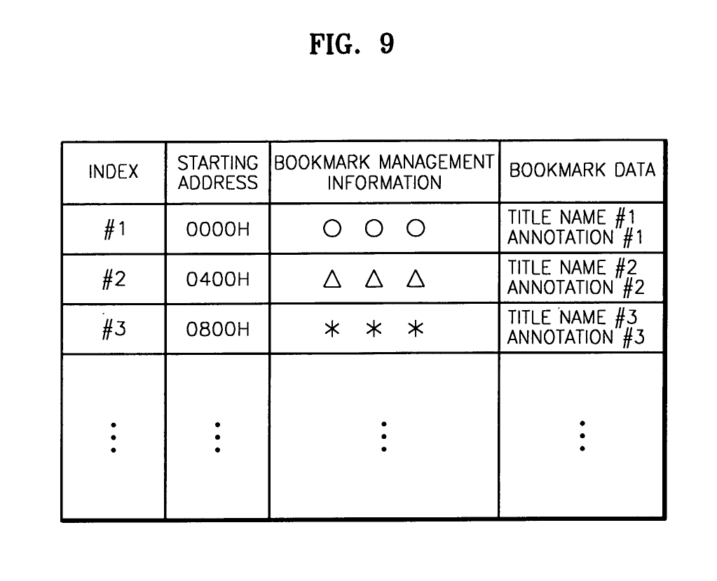

FIG. 9 shows an example of a bookmark table which stores bookmark information according to the present invention. Referring to FIG. 9, the fields of the bookmark table comprise an index, a starting address, bookmark management information, and bookmark data. The starting address indicates a beginning location of the bookmark information in the non-volatile memory 33. As described above, the bookmark management information contains information necessary for navigating bookmark data, and the bookmark data contains the title name of the bookmarked content and the annotation.

A method of providing bookmark information according to the present invention will be described based on the above configuration.

A method of providing bookmark information according to the present invention comprises at least one of the following methods: sending bookmark information from one reproducing apparatus to another reproducing apparatus, storing received bookmark information, and reproducing the stored bookmark information.

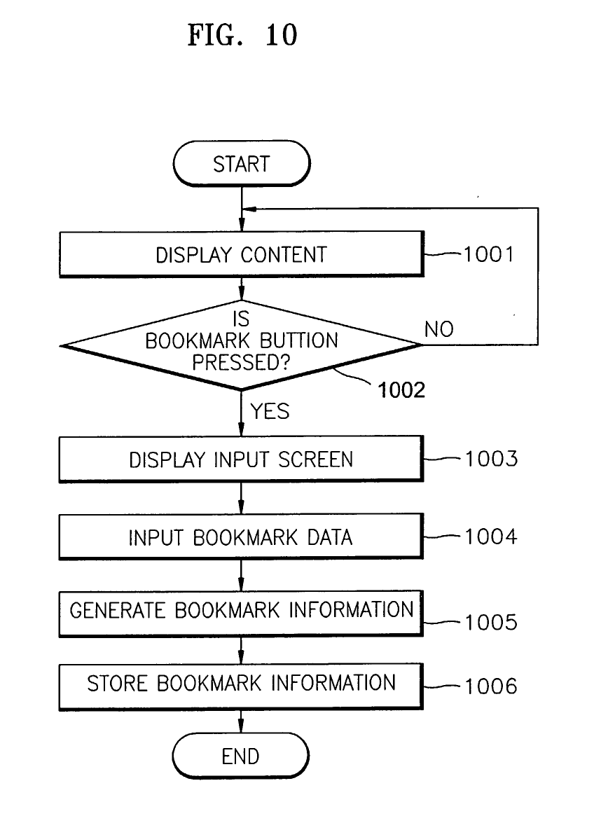

FIG. 10 is a flowchart of a method of storing bookmark information. Referring to FIG. 10, while one reproducing apparatus 1 is displaying content (AV data recorded on the optical disc 300 or a web document received through an Internet server) at operation 1001, a user presses a bookmark button (not shown) provided on the reproducing apparatus 1 in order to bookmark a predetermined location of the content at operation 1002, and the controller 30 displays an input screen at operation 1003 for allowing the user to input bookmark data. The user inputs the title name of the content and an annotation on the input screen, and the controller section 30 receives the input bookmark data at operation 1004. The controller section 30 extracts relevant information from, for example, navigation information, a web document, or header information of a multimedia file recorded on the optical disc 300, to generate bookmark management information and generates the bookmark information by combining the bookmark management information with the bookmark data at operation 1005. Next, the controller section 30 stores the generated bookmark information at operation 1006. More specifically, where it is determined that the optical disc 300 is a DVD-Video based on the recording type of content, the controller section 30 stores the bookmark information according to a data structure defined for a DVD-Video. Where it is determined that the optical disc 300 is a DVD-Interactive, the controller section 30 stores the bookmark information according to a data structure defined for a DVD-Interactive. Where it is determined that the content is a web document, the controller section 30 stores the bookmark data in the form of a URL.

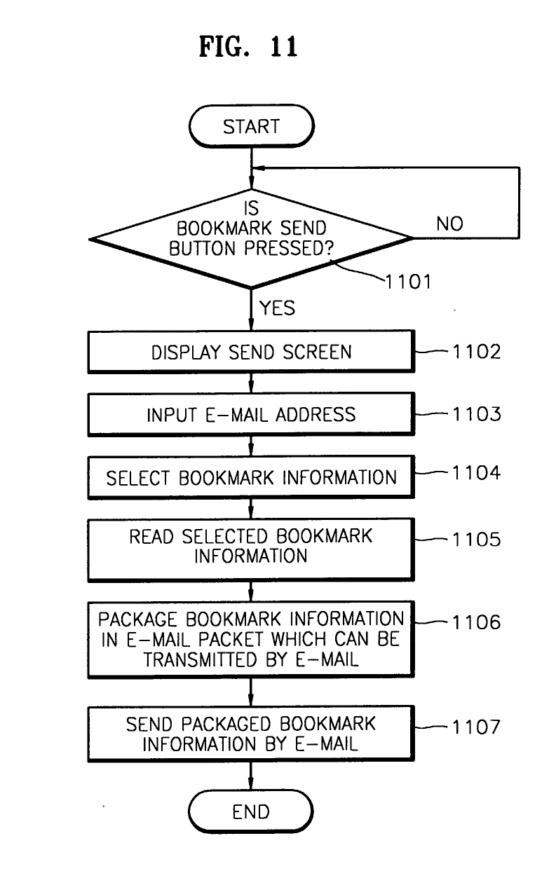

FIG. 11 is a flowchart of a method of sending bookmark information. Referring to FIG. 11, a user presses a bookmark send button (not shown) at operation 1101, and the controller section 30 displays a send screen for sending bookmark information at operation 1102. The user inputs an e-mail address at operation 1103 and selects bookmark information at operation 1104 on the send screen and the controller section 30 reads the selected bookmark information from the non-volatile memory 33 or the optical disc 300 at operation 1105. Next, the controller section 30 packages the read bookmark information in a data format allowing e-mail transmission, i.e., an e-mail packet, at operation 1106. A representative data format allowing e-mail transmission is Multi-purpose Internet Mail Extensions (MIME). MIME is extended from a Simple Mail Transfer Protocol (SMTP) that can process ASCII data only so as to allow transfer of audio data, video data, images, application programs, and other various data files. Internet servers embed an MIME header in data for transmission, and clients select an application program for reproducing the transmitted data referring to a data format recorded in the header. Application programs frequently used are basically installed in a browser.

The controller section 30 sends the packaged bookmark information to the e-mail address input at operation 1103 via e-mail at operation 1107.

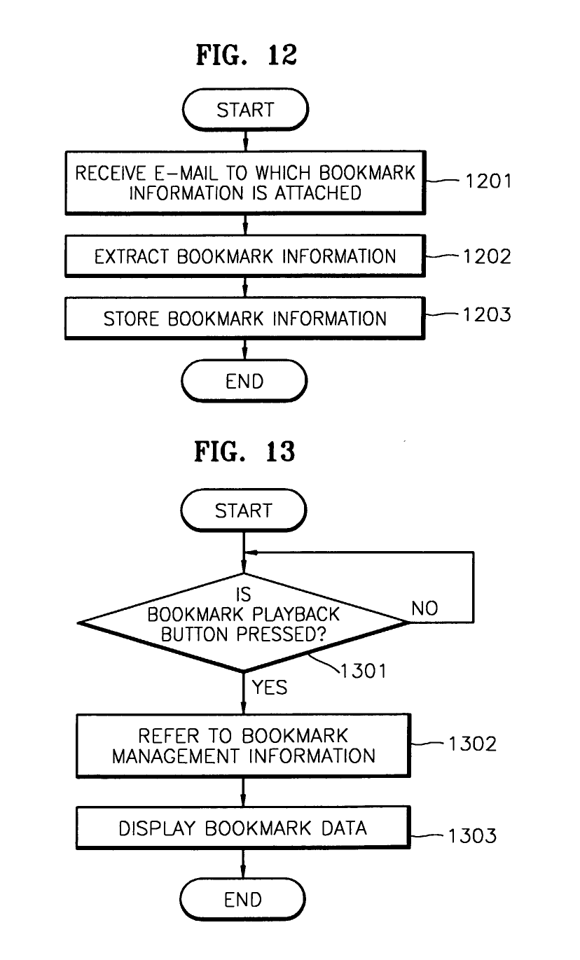

FIG. 12 is a flowchart of a method of storing received bookmark information. Referring to FIG. 12, the controller section 30 receives e-mail to which bookmark information is attached at operation 1201, extracts the bookmark information from the received e-mail at operation 1202, and stores the bookmark information in the non-volatile memory 33 or the optical disc 300 at operation 1203.

FIG. 13 is a flowchart of a method of displaying stored bookmark information. Referring to FIG. 13, while the reproducing apparatus 1 reproduces the content, if a user presses a bookmark playback button (not shown) at operation 1301, the controller section 30 refers to bookmark management information contained in the bookmark information at operation 1302 to display bookmark data at operation 1303. More specifically, after referring to a recording type as bookmark information, the controller section 30 and the playback section 40 decode bookmark data according to a data structure defined for a DVD-Video to reproduce the bookmark data, where it is determined that the optical disc 300 is a DVD-Video. After referring to the recording type as bookmark information, the controller section 30 and the playback section 40 decode bookmark information according to a data structure defined for a DVD-Interactive to reproduce the bookmark information, where it is determined that the optical disc 300 is a DVD-Interactive. The controller section 30 and the playback section 40 display bookmark data in the form of a URL where it is determined that the content is a web document.

As described above, the present invention allows a user to bookmark a particular location in predetermined content and to annotate the content. In addition, according to the present invention, bookmark information stored in one reproducing apparatus can be sent to another reproducing apparatus through a communications channel, such as for example, the Internet. Thus, one reproducing apparatus may receive bookmark information from another reproducing apparatus and display and use the bookmark information.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of providing bookmark information for a reproducing apparatus, which reproduces content recorded on an information storage medium, the method comprising:
storing bookmark information comprising an annotation input by a user with respect to selected content and a locator necessary for reproducing the selected content; and
sending the bookmark information to another reproducing apparatus through the Internet.

2. The method of claim 1, further comprising displaying the bookmark information.

3. The method of claim 1, wherein the storing of the bookmark information comprises:
reading the locator from navigation information recorded on the information storage medium; and
generating the bookmark information by combining the read locator and the annotation.

4. The method of claim 1, wherein the storing of the bookmark information comprises:
storing the bookmark information in the information storage medium where the information storage medium on which the content is recorded is in a recordable state; and
storing the bookmark information in a recordable non-volatile memory where the optical recording medium on which the content is recorded is not in a recordable state.

5. The method of claim 1, wherein the storing of the bookmark information further comprises:
storing a recording type of content; and
storing a title name of the content.

6. The method of claim 5, wherein the storing of the recording type of the content comprises reading the recording type of the content from the information storage medium, on which the content is recorded, and storing the recording type.

7. The method of claim 5, wherein the storing of the title name comprises reading the title name of the content from the information storage medium, on which the content is recorded, and storing the title name.

8. The method of claim 1, wherein the sending of the bookmark information comprises sending and receiving the bookmark information by electronic mail.

9. The method of claim 8, wherein the sending of the bookmark information by electronic mail comprises:
converting the bookmark information into a format, which is transferable by electronic mail;
attaching the converted bookmark information to the electronic mail; and
sending the electronic mail.

10. A method of providing bookmark information for a first reproducing apparatus, which reproduces content recorded on an information storage medium, the method comprising:
receiving bookmark information comprising an annotation input by a user of a second reproducing apparatus with respect to selected content and a locator necessary for reproducing the selected content from the reproducing apparatus through the Internet; and
storing the bookmark information.

11. The method of claim 10, wherein the storing of the bookmark information further comprises:
storing a recording type of content; and
storing a title name of the content.

12. The method of claim 11, wherein the storing to the recording type of the content comprises reading the recording type of the content from the information storage medium, on which the content is recorded, and storing the recording type.

13. The method of claim 11, wherein the storing to the title name of the content comprises reading the title name of the content from the information storage medium, on which the content is recorded, and storing the title name.

14. The method of claim 10, wherein the receiving of the bookmark information comprises receiving the bookmark information by electronic mail.

15. The method of claim 14, wherein the receiving of the bookmark information by electronic mail comprises:
detaching the bookmark information from the electronic mail;
converting the detached bookmark information into a format which is usable by the first reproducing apparatus; and
storing the detached bookmark information in the first reproducing apparatus.

16. A reproducing apparatus comprising:
a reader section which reads predetermined data from an information storage medium;
a playback section which reproduces content provided from the reader section;
a controller section which stores bookmark information comprising a locator necessary for reproducing content starting from a location selected by a user while the content is being reproduced by the playback section and an annotation with respect to the content; and
an Internet access section which sends the bookmark information to another reproducing apparatus through the Internet under the control of the controller section.

17. The reproducing apparatus of claim 16, wherein the controller section stores the bookmark information in the information storage medium where the information storage medium is in a recordable state.

18. The reproducing apparatus of claim 16, wherein the controller section stores the bookmark information at a section of an area in which navigation information is stored on the information storage medium.

19. The reproducing apparatus of claim 16, wherein the controller section stores the bookmark information in a recordable non-volatile memory.

20. The reproducing apparatus of claim 19, wherein the controller section attaches the bookmark information to electronic mail and sends the electronic mail to another reproducing apparatus through the Internet access section.

21. The reproducing apparatus of claim 20, wherein the controller section converts the bookmark information into a format, which is transferable by electronic mail, attaches the converted bookmark information to the electronic mail, and sends the electronic mail.

22. The reproducing apparatus of claim 21, wherein the controller section comprises a non-volatile memory, in which an electronic mail program code is stored, and a processor, which operates as an electronic mail client by executing the electronic mail program code.

23. The reproducing apparatus of claim 16, wherein the controller section receives predetermined content from an Internet server and displays the predetermined content.

24. The reproducing apparatus of claim 23, wherein the controller section comprises a non-volatile memory, in which a browser program code is stored, and a processor, which operates as a browser by executing the browser program code.

25. The reproducing apparatus of claim 16, wherein the bookmark information further comprises a recording type of the content and a title name of the content.

26. The reproducing apparatus of claim 25, wherein the reader section reads the recording type and the title name from the information storage medium, on which the content is recorded.

27. A reproducing apparatus comprising:
a reader section which reads predetermined data from an information storage medium;
a playback section which reproduces content provided from the reader section;
an Internet access section which receives bookmark information comprising a locator necessary for reproducing content starting from a selected location and an annotation with respect to the content from another reproducing apparatus through the Internet; and
a controller section which stores the bookmark information received through the Internet access section or displays the stored bookmark information.

28. The reproducing apparatus of claim 27, wherein the controller section stores the bookmark information in the information storage medium where the information storage medium is in a recordable state.

29. The reproducing apparatus of claim 28, wherein the controller section stores the bookmark information in a recordable non-volatile memory.

30. The reproducing apparatus of claim 29, wherein the controller section attaches the bookmark information to electronic mail and sends the electronic mail to another reproducing apparatus through the Internet access section.

31. The reproducing apparatus of claim 30, wherein the controller section converts the bookmark information into a format, which is transferable by electronic mail, attaches the converted bookmark information to the electronic mail, and sends the electronic mail.

32. The reproducing apparatus of claim 31, wherein the controller section comprises a non-volatile memory, in which an electronic mail program code is stored, and a processor, which operates as an electronic mail client by executing the electronic mail program code.

33. The reproducing apparatus of claim 27, wherein the bookmark information further comprises a recording type of content and a title name of the content.

34. A method of communicating information about a reproducible presentation from a user of a first reproducing apparatus to a user of a second reproducing apparatus, the method comprising:
designating a portion of the reproducible presentation while performing the reproducible presentation on the first reproducing apparatus;
generating data comprising:
an identifier of the reproducible presentation,
a starting address of the designated portion, and
an annotation about the designated portion;
providing the generated data to the second reproducing apparatus via a communications link; and
performing the designated portion of the reproducible presentation and the annotation on the second reproducing apparatus based on the generated data.

35. The method of claim 34, wherein the first and second reproducing apparatuses access a common storage media to perform the reproducible presentation.

36. The method of claim 34, wherein the first reproducing apparatus accesses a first storage media to perform the reproducible presentation and the second reproducing apparatus accesses a second storage media, having a starting address of the designated portion which corresponds with the starting address in the generated data, to perform the reproducible presentation.

37. The method of claim 34, wherein:
the providing of the generated data to the second reproducing apparatus comprises sending the generated data via e-mail.

38. The method of claim 34, wherein the reproducible presentation is a video presentation.

39. The method of claim 34, wherein the reproducible presentation is an audio presentation.

40. The method of claim 34, wherein the reproducible presentation is a multimedia presentation.

41. The method of claim 34, wherein the reproducible presentation is a DVD-Video presentation.

42. The method of claim 34, wherein the reproducible presentation is a DVD-Interactive presentation.

43. The method of claim 34, wherein the reproducible presentation is a HD-DVD presentation.

44. The method of claim 34, wherein the reproducible presentation is a DVD-audio presentation.

45. A data structure for communicating information about a reproducible presentation from a user of a first reproducing apparatus to a user of a second reproducing apparatus, the data structure comprising:
a recording type of the reproducible presentation;
a locator which designates a portion of the reproducible presentation identified by the user of the first reproducing apparatus;
a title name of the reproducible presentation, and
an annotation provided by the user of the first reproducing apparatus and corresponding to the designated portion.

46. The data structure of claim 45, further comprising an index number which links the annotation and the designated portion.
